(19) United States
(12) Patent Application Publication
(10) Pub. No.: US 2023/0313556 A1
(43) Pub. Date: Oct. 5, 2023

(54) Vehicle Cargo Bay Tent Structures

(71) Applicants: Lun Xu, Pasadena, CA (US); Xuduo Wen, Pasadena, CA (US); Li Chen, Yinzhou (CN)

(72) Inventors: Lun Xu, Pasadena, CA (US); Xuduo Wen, Pasadena, CA (US); Li Chen, Yinzhou (CN)

(21) Appl. No.: 17/712,371

(22) Filed: Apr. 4, 2022

(51) Int. Cl. E04H 15/38; E04H 15/06; E04H 15/12; E04H 15/40; E04H 15/54; F21S 9/03

(52) U.S. Cl. CPC E04H 15/38; E04H 15/06; E04H 15/12; E04H 15/405; E04H 15/54; F21S 9/032; F21Y 2115/10

(57) ABSTRACT

An adjustable tent structure for use with and incorporation into the cargo bay sections of a range of vehicles or pickup trucks is disclosed. The tent structure elements include a plurality of flexible poles that, when assembled, form the tent skeletal structure; a tent cover section that is attached to the plurality of flexible poles and forms the tent structure. The adjustable entryway configuration of the tent structure allows for use within a wide variety of vehicle cargo bay sizes. Accordingly, the tent structure may be used in, and fit in smaller truck cargo bay, as well as a larger vehicle cargo bay, where the vehicle cargo bay has different lengths and/or widths. The tent structure has a plurality of tie-downs that may be attached, for stability of the tent structure, to the vehicle cargo bay, other vehicle structure, and/or to the ground surrounding the vehicle.

### BACKGROUND

Tents and tent-type structures are widely used in a very broad spectrum of applications. Indeed, tents are used for a multitude of activities including applications such as camping, beach time, sun protection, wind and rain protection, play tents, pet enclosures, and even shower or changing enclosures. Depending upon the design and covering, such structures and coverings provide protection from wind, rain, and, especially in the beach environment, protection from the sun and ultraviolet light. One important feature for most all tent structures used in an outdoor temporary setting is that the structure must be readily portable so that it can be transported to where it will be used, and readily storable when not in use.

While camping tents have been designed and used as independent structures in many forms and varieties, the use of a tent structure as part of a vehicle cargo bay has been limited. In part, the limited use of tents within vehicle cargo bays is because such cargo bays come in a wide range of sizes, widths, and lengths. Any one specific tent design, having fixed dimensions would accordingly only fit and work with one type, or a limited range of vehicles.

Different types of tent-type structures have been created and commercialized to address some of these concerns and issues. While there have been many such designs, and indeed, new designs continue to evolve, none appear to provide an optimal or even widely accepted solution for a tent structure that can be used within a wide variety of different size vehicle cargo bays, and still retain the key and core features of being lightweight, easily transported, readily storable, easily assembled, and easily disassembled. While some designs provide for some flexibility with respect to the structure and size of the tent, such size and configuration flexibility is very limited, and generally does not provide ready means for using a tent structure in different vehicle cargo bays with such cargo bays have different dimensions.

One example of such a prior art system includes U.S. Pat. No. 6,749,252 for a Fold-Out Camper For A Pick-Up Truck, by Cervenka. The Cervenka '252 patent, discloses a fold-out camper which is mounted in the bed of a truck [and] provides a convenient shelter. The shelter includes an upper and lower frame which, when retracted, are contained within the truck bed without obstructing the cargo area of the bed. The Cervenka patent discloses a tent structure that appears to be fixed to a specific vehicle have set dimensions, and does not disclose or teach any means for varying the size or any dimensions of the tent structure for use in different vehicles having different sized cargo bays.

A second example of such a prior art system includes U.S. patent application Ser. No. 11/590,521 for a Mobile Truck Tent of Adjustable Height, by Stabile. The Stabile '521 application, discloses a portable truck tent made of steel tubing, having a durable cover, and containing two built-in bench seats. The '521 application further discloses the use of interlocking pins in the frame of the bench seats to allow for enlargement of the bench seat to adjust to varying lengths and widths of different trucks. While the Stabile '521 application discloses a tent structure that appears to be useable with vehicles having different cargo bay dimensions, the disclosure and design by Stabile does not teach or allow for easy portability of the tent structure, or disassembly into a compact size and shape. The Stabile '521 multiple steel tubing elements appear to be difficult and complex to assemble and disassemble, making use of the product limited.

Accordingly, it would be useful to have a portable and adjustable tent structure that can be used within a range of vehicle cargo bays such that the tent structure would be portable between different vehicles, and still properly fit within, and be able to be readily used within different size and length vehicle cargo bays. Such an innovative tent structure could include, in addition to the adjustable size feature, additional features such as roof sections having transparent sections to allow for night sky viewing, and photovoltaic panels with batteries and lighting elements to enhance the utility of the tents within the vehicles.

The adjustable vehicle cargo bay tent structure should be easily assembled or deployed, and easily disassembled. Moreover, the tent structure should be lightweight, and in the disassembled or folded configuration, be easy to store and transport. Such an adjustable vehicle cargo bay tent structure does not appear to have been designed, developed, or commercialized that satisfactorily meets each of these criteria. While certain of these problems may be addressed by one or more examples of the prior art, a complete solution to all of these problems does not appear to have been specifically designed or used in the relevant prior art.

### SUMMARY OF THE INVENTION

The present invention overcomes the disadvantages of the prior art and fulfills the needs described above by providing an adjustable vehicle cargo bay tent structure that includes a plurality of flexible ribs, a flexible cover, and at least one adjustable connecting strap to allow for adjustment of the length of the vehicle cargo bay tent structure.

One preferred embodiment of the invention is an adjustable tent structure for use in a vehicle cargo bay, comprising, a plurality of flexible ribs that form a skeletal shape for a main section of said adjustable tent structure and a skeletal shape for an entryway of said adjustable tent structure; a flexible cover attachable to said plurality of flexible ribs to form said main section and said entryway of said tent structure; at least one adjustable connecting strap, having an adjustable length, wherein said at least one adjustable connecting strap is connected at one end to an end of one of said plurality of flexible ribs, and connected at the other end of said adjustable connecting strap to an end of a second of said plurality of flexible ribs, wherein by increasing the length of said at least one adjustable connecting strap increases the length of said tent structure entryway, and by decreasing the length of said at least one adjustable connecting strap decreases the length of said tent structure entryway; and a plurality of tie-down elements to attach said plurality of flexible ribs and said flexible cover to a stable element.

A second preferred embodiment of the invention is an adjustable tent structure for use in a vehicle cargo bay, comprising, a plurality of flexible ribs that form a skeletal shape for a main section of said adjustable tent structure and a skeletal shape for an entryway of said adjustable tent structure; a flexible cover attachable to said plurality of flexible ribs to form said main section and said entryway of said tent structure; at least one adjustable connecting strap, having an adjustable length, wherein said at least one adjustable connecting strap is connected at one end to an end of one of said plurality of flexible ribs, and connected at the other end of said adjustable connecting strap to an end of a second of said plurality of flexible ribs, wherein by increasing the length of said at least one adjustable connecting strap increases the length of said tent structure entryway, and by decreasing the length of said at least one adjustable connecting strap decreases the length of said tent structure entryway; and a plurality of tie-down elements to attach said plurality of flexible ribs and said flexible cover to a stable element; and further comprising at least one openable door at an end of said entryway of said tent structure, and/or further comprising at least one openable window within said flexible cover.

A third preferred embodiment of the invention is an adjustable tent structure for use in a vehicle cargo bay, comprising a first and second flexible rib that cross each other in an approximate orthogonal configuration to form a skeletal shape for a main section of said adjustable tent structure; a third flexible rib that forms a skeletal shape for an entryway of said adjustable tent structure; a flexible cover attachable to said first, second, and third flexible ribs to form said main section and said entryway of said tent structure; at least one adjustable connecting strap, having an adjustable length, wherein said at least one adjustable connecting strap is connected at one end to an end of one of said first flexible rib, and connected at the other end of said adjustable connecting strap to an end of said third flexible rib, wherein by increasing the length of said at least one adjustable connecting strap increases the length of said tent structure entryway, and by decreasing the length of said at least one adjustable connecting strap decreases the length of said tent structure entryway; and a plurality of tie-down elements to attach said first, second, and third flexible ribs, and said flexible cover to a stable element.

### BRIEF DESCRIPTION OF THE DRAWINGS

To easily identify the discussion of any particular element or act, consistent element numbers refer to such elements in different figures.

FIG. 1A is a perspective or isometric front view of an embodiment of the inventive vehicle cargo bay tent with a shortened entryway and windows.

FIG. 1B is a perspective or isometric front view of an embodiment of the inventive vehicle cargo bay tent with a lengthened entryway and windows.

FIG. 2A is a perspective or isometric front view of another embodiment of the inventive vehicle cargo bay tent with a shortened entryway.

FIG. 2B is a perspective or isometric front view of an embodiment of the inventive vehicle cargo bay tent with a lengthened entryway.

FIG. 3 is a perspective or isometric front view of an embodiment of the inventive vehicle cargo bay tent, along with an exploded view of the same image, showing the collecting loops to gather and collect extra entryway cover material when the tent is in a shortened configuration.

FIG. 4 is a perspective or isometric front view of an embodiment of the inventive vehicle cargo bay tent showing the entryway door in an open configuration.

FIG. 5 is a perspective or isometric view of an embodiment of the inventive vehicle cargo bay tent shown deployed within the cargo bay of a truck.

FIG. 6A through 6E illustrate a sequence for disassembling and collapsing an embodiment of the inventive vehicle cargo bay tent.

FIG. 7 is a perspective or isometric view of an embodiment of the inventive vehicle cargo bay tent shown deployed within the cargo bay of a truck and having a transparent section in the tent roof line for stargazing.

FIG. 8 is a perspective or isometric view of an embodiment of the inventive vehicle cargo bay tent with photovoltaic (“PV”) solar panels, lighting elements, and electrical storage batteries.

FIG. 9 is a perspective or isometric view of an embodiment of the inventive vehicle cargo bay tent with heat generators within the sides and floor of the tent.

FIG. 10 is a perspective or isometric view of an embodiment of the inventive vehicle cargo bay tent shown with the rainfly cover over the deployed tent.

### DETAILED DESCRIPTION OF CERTAIN EMBODIMENTS

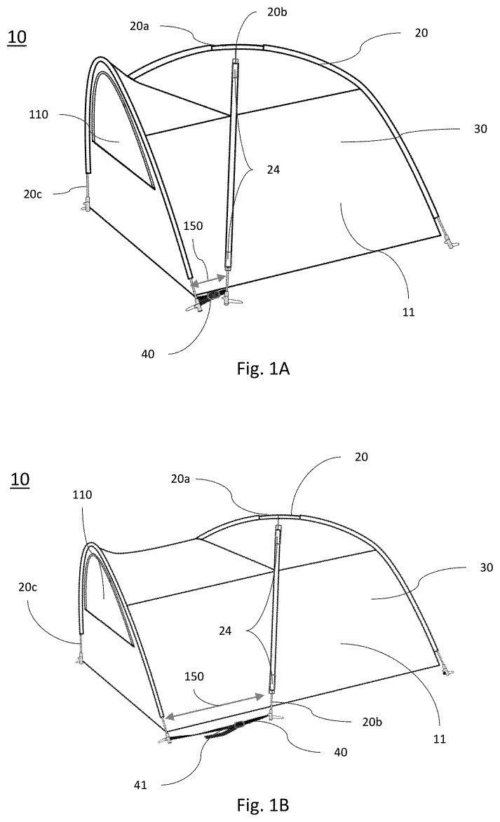

An innovative adjustable tent structure for use within the cargo bays of motor vehicles is disclosed and described in various relevant and useful embodiments. The vehicle cargo bay tent structure 10 is shown in different embodiments in FIGS. 1A through 10.

At its core, the adjustable vehicle cargo bay tent structure 10 is comprised of a plurality of flexible ribs 20, a cover 30, and at least one adjustable length connecting strap 40. As shown, in one embodiment in FIGS. 1A and 1B, the tent structure 10 may be assembled having three flexible ribs 20a, 20b, 20c that form the skeletal support structure of the tent structure 10, including both a main section 11 and an adjustable length entryway 12, to which the cover 30 is attached.

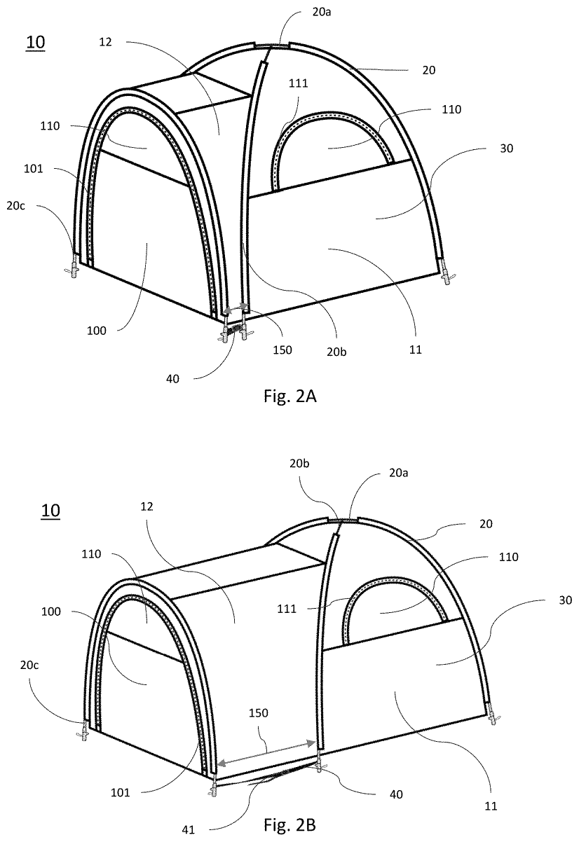

For an exemplary embodiment, as shown in FIGS. 1A and 1B, the connecting strap 40 is attached at one end to an end of one of the flexible ribs 20a that forms the main section 11 of the tent structure 10, and attached at the other end of the connecting strap 40 to one end of another of the flexible ribs 20c that forms the entryway 12. With the connecting strap 40 shortened in length, as shown in FIG. 1A, the entryway 12 is shortened, and the tent structure fits within a shorter length vehicle cargo bay. With the connecting strap 40 extended in length, as shown in FIGS. 1B and 5, the entryway 12 is extended in length, and the tent structure fits within a longer vehicle cargo bay. As shown in FIGS. 1A through 2B, the adjustable length connecting strap may be adjusted in length using a standard buckle mechanism 41.

While not shown in FIGS. 1A through 2B, the embodiment of the adjustable vehicle cargo bay tent structure could have two or more adjustable length connecting straps 40, such that there is at least one connecting strap 40 on each side of the tent. Such a configuration allows for further tent stability, once deployed, and also allows the user to orient or tilt the front doorway to the left or right. Such added control by using two or more connecting straps 40 allows the user to position the doorway away from, or into the wind direction.

The adjustable length connecting straps 40 may be manufactured from a wide variety of materials including textile, such as woven polyester, which is very flexible and lightweight; or composite material such as high tensile strength polyester yarn encased in a weatherproof coating of polypropylene. Other potential materials for the connecting straps 40 are bungee cords or elastic rope, or simply rope material.

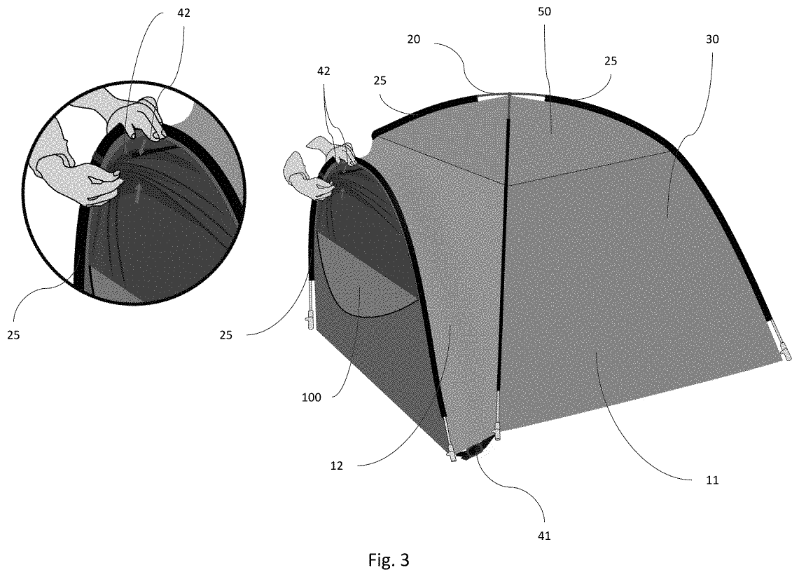

In addition to the adjustable length connecting straps 40, which allows users to vary the length and size of the tent structure 10 to fit within different cargo bays, in preferred embodiments of the tent structure, one or more collecting loops 42 may be incorporated at the top of the entryway 12, as shown in FIG. 3, such that when the tent structure 10 is deployed in a shortened configuration, the additional cover material at the top of the entryway 12 may be collected and neatly held in play by the collecting loops 42. The collecting loops 42 may be formed from standard hook and loop textile materials to allow for easy collection and storage of the additional cover material, and then easy release of the additional cover material when the tent structure 10 is deployed in the longer or extended length configuration, as shown in FIGS. 1B, 2B, and 3.

In an alternative embodiment of the tent structure, having additional windows 110 incorporated into the tent structure 10 main section 11, the tent structure 10 is again shown, in FIGS. 2A and 2B, having three flexible ribs 20a, 20b, 20c, a flexible cover 30, and an adjustable length connecting strap 40.

In the embodiments shown in FIGS. 1A through 2B, the flexible ribs 20a, 20b, 20c that form the skeletal structure for the tent structure 10, are single element ribs. In another embodiment, the flexible ribs 20 may be formed from a plurality of sub-support rib sections that are interconnected to form the flexible ribs 20.

The cover 30 may be attached to the flexible support ribs 20a, 20b, 20c through the use of various fasteners 24. Such fasteners could be, in different embodiments, textile hook and loop sections and/or tie ends. In another embodiment, the cover 30 may be formed with sleeve sections 25 through which the flexible ribs 20 are slid to form the tent structure 10 as shown two different embodiments in FIGS. 1A through 2B.

To allow for user ease of use and comfort, as shown in FIGS. 1A through 5, the tent structure 10 may also incorporate one or more door sections 100 and window sections 110. The door section 100 may be opened or closed through fasteners 101, which in one embodiment as shown in FIGS. 1A and 1B, may be a zipper 101. Similarly, the window section 110 may be opened or closed through use of fasteners 111, which in one embodiment, as shown in FIGS. 2A and 2B, may again be a zipper 111. Alternative forms of fasteners that may be equally applicable and useful are snaps, buttons, or attracting magnet elements that are embedded into the cover 30 and door section 100 or window section 110 edges, or hook and loop textile material or strips.

The door 100 and window 110 sections may be incorporated into the flexible cover 30 in a variety of configurations. For example, FIGS. 1A and 1B show a window 110 within the entryway door 100. Alternatively, as shown in FIGS. 2A and 2B, the window section 110 could be included within the door section 100 as well as part of the side of the tent structure 10.

As described above, and shown in FIGS. 1A through 2B, a core feature of the adjustable tent structure 10 is the ability to adjust the entryway length 150 so that the tent structure 10 can readily fit within a range of vehicle cargo bay lengths, with one example of an extended entryway 12 deployment shown in FIG. 5. The design as shown allows for a completely variable adjustment of the length of the entryway 12, such that the tent structure 10 is capable of fitting within, and being used with a wide range of vehicles having varied cargo bay dimensions.

A further feature of the tent structure 10 may be the use of one or more sections 51 in the tent structure 10 roof section 50, that is transparent to allow unaided viewing of the night sky, as shown in FIG. 7. In a preferred embodiment, the transparent section 51 of the upper section 50 should be at least 33% of the total area of the tent structure roof section 50.

As shown, the door section 100, once unzipped, or unfastened, may be readily rolled up towards the top of the tent structure, and secured in the rolled up configuration, to allow open access into the tent structure 10. Similarly, the window section 110, once unzipped, or unfastened, may be readily rolled up or down, depending upon the window orientation, to allow air into or out of the tent structure 10. In the embodiment shown, with the window section 110 open, wind and air flow are allowed to pass into the tent structure 10, but still provide a high level of protection from sand or other wind-blown objects. Such window sections 110 also allow users to see out of the tent structure 10.

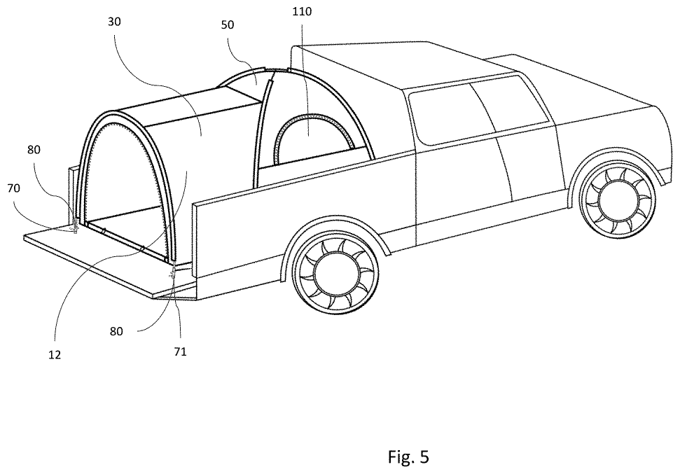

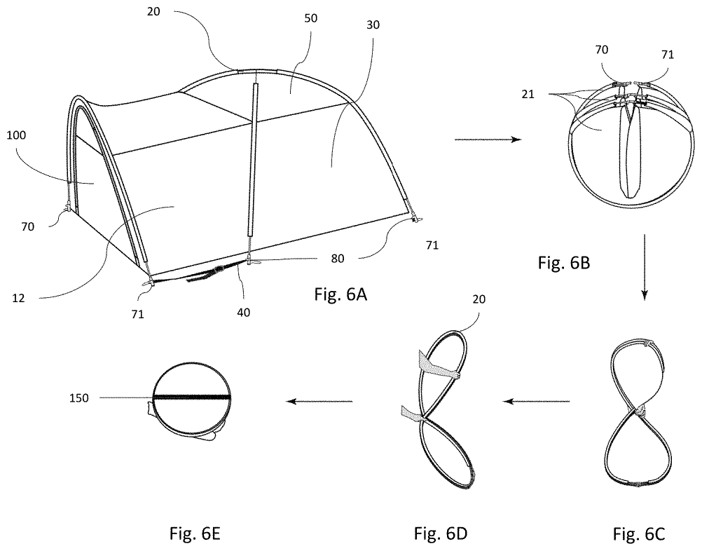

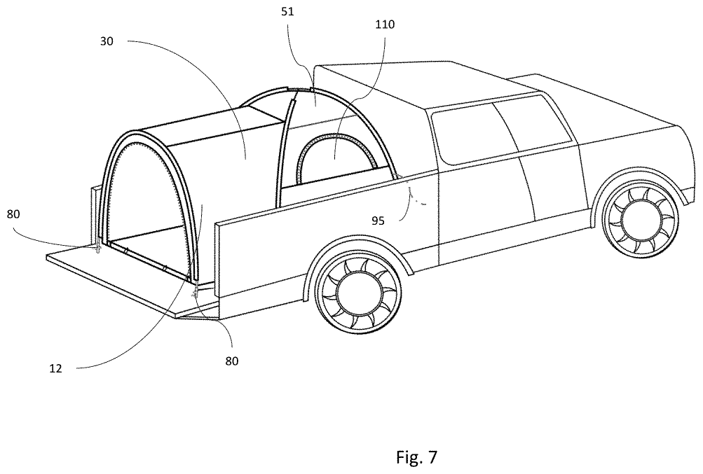

Disassembly or collapsing of the vehicle cargo bay tent structure 10 into a convenient transportation or storage configuration is easily achieved, as illustrated in FIGS. 6A through 6E. More specifically, the flexible ribs 20 may be first connected end-to-end such that each flexible rib forms a circular shape, as illustrated in FIG. 6B. The connection of the flexible ribs 20, end-to-end, may be accomplished using connection elements 70, 71 that also provide the feet 80 of the flexible ribs 20. The connection elements 70, 71 may be connected using a variety of fastener mechanisms, including a press-fit mechanism, a quarter-turn lock mechanism, or a screw-type mechanism.

Second, each of the flexible rib circles or discs 21 are stacked on top of each other. Next, the flexible discs 21 may be readily collapsed by pulling opposite sides of the “circles” together to create an hour-glass shape or figure eight shape. Then with a slight twisting motion, one half of the figure-eight shape is folded on top of the other half of the figure-eight shape to form essentially a disc configuration as illustrated in FIGS. 6C and 6D. The number of discs is dependent upon the number of flexible ribs 20 used in the setup of the adjustable tent structure 10. More particularly, for a tent with three poles, as illustrated in FIG. 6A, there will be three discs in the disassembled, and folded configuration, while for a tent with four flexible ribs 20, there will be four discs in the fully folded configuration. When fully collapsed, the vehicle cargo bay tent structure 10 is fairly compact, and may be placed within a bag or sack 210 (not shown), that may be shaped to properly fit the folded tent structure.

Once in the “discs” or collapsed configuration, a strap or other securing element 150 may be used to keep each of the discs in place adjacent to and in relation to each of the other discs as shown in FIG. 6E. Alternatively, there may be clips, hook and loop (Velcro®) pieces, buckle, button, clasp, snap, or other similar type of securing mechanisms 150 that can be used to maintain the discs in approximate position next to each other in the folded configuration.

The assembly or setup of the vehicle cargo bay tent structure 10 is undertaken in the opposite steps to that described above for disassembly. The securing mechanisms or clips 150 may be released to allow the discs to separate from each other. With a little urging, each of the discs 21 may be untwisted and unfolded to form the figure-eight shape. Once in this configuration, the tendency of the flexible ribs 20 will be to flex into their normal circular configurations as constrained by the flexible cover 30. Once the discs 21 are released, then the flexible rib ends or connectors may be disconnected from each other, and the adjustable tent structure will unfold into the fully deployed shape defined by the flexible cover 30 and flexible ribs 20, with one embodiment for such fully deployed shaped being shown in FIG. 1A.

In a further embodiment, where the vehicle cargo bay tent structure 10 is formed from a larger set of flexible ribs 20, the folding or collapsing process may be repeated to provide for smaller discs. By way of example, the substantially circular flexible ribs 20 may be collapsed into an hour-glass shape or figure eight shape, and then with a slight twisting motion, one half of the figure-eight shape is folded on top of the other half of the figure-eight shape to form two stacked discs. This process may be repeated by pulling the sides of the stacked discs together to form a smaller hour-glass or figure eight shape, and then as above, with a slight twisting motion, one half of the figure-eight shape may be folded on top of the other section of the figure-eight shape to now form a stack of four discs. In the same fashion, where the stacked discs are large, and further collapsing is possible, the four stacked discs may be further collapsed and folded to form a stack of eight discs.

With each of these collapsing or folding sets, the size of the collapsed disc is approximately one-half the diameter of the disc section prior to folding. Accordingly, where the original flexible support pole circle is 2 meters in diameter, one folding step results in a collapsed set of discs of approximately 1 meters, and a second folding step results in a further collapsed set of discs of approximately ½ meter.

As shown in FIGS. 1A through 5, the flexible cover 30 may be configured with one or more doors 100 and windows 110. The doors 110 are to allow users to easily enter and leave the tent structure 10. The windows 110 allow the users to see out of the tent structure, and to allow others to see into the tent structure 10. The windows 110 also allow wind to pass through but to still provide a level of protection from sand or other wind-blown objects. Such a window also allows users to see out of the tent structure. The tent structure may also be configured with flexible shades (not shown) that can be positioned over the windows to provide some privacy and to block wind.

In order to balance the elements of strength, durability, and weight, the flexible ribs 20 may be manufactured from any type of resilient thermoplastic or composite material. The flexible cover 30 may be manufactured from most any type of lightweight, flexible textile, such as nylon ripstop or similar types of polyester fabrics. Alternative and additional materials that may be used to manufacture some or the entirety of the flexible cover 30 include polyester, canvas, polyvinylchloride (PVC), polyethylene, as well as other flexible textiles and poly-type materials.

In a similar fashion, one or more cutouts 120 may be incorporated into the cover 30, to allow for release of air pressure when wind blows into the tent structure 10. Such cutouts help to maintain the tent structure 10 from inadvertently ballooning like a parachute, and moving when the wind blows and catches within the tent structure 10.

While shown in a particular “igloo” configuration in FIGS. 1A through 10, the vehicle cargo bay tent structure 10 may be designed and configured into most any shape or size, including by way of example, and not by way of limitation, as a cube, cylinder, or a teepee shape. Similarly, in addition to the ability to adjust the length of the tent structure 10, the tent structure 10 may be manufactured in different sizes, including variations in height and width.

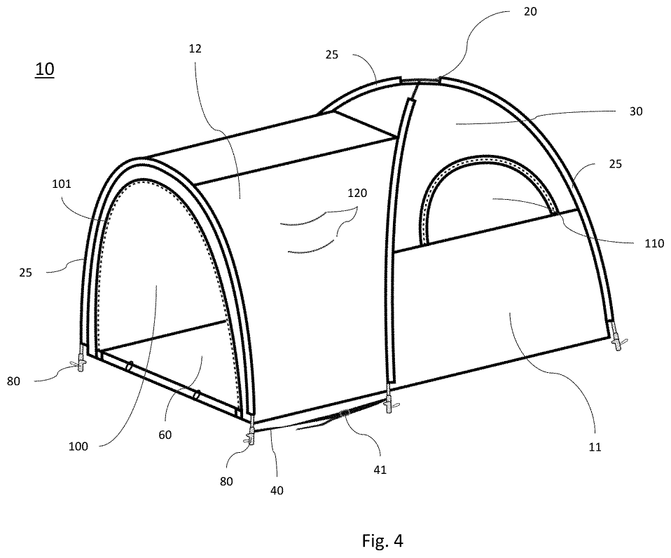

A further embodiment of the vehicle cargo bay tent structure 10 may include a floor section 60, as shown in FIG. 4, that would be attached to the flexible cover 30 and ribs 20, and provide the user with some protection and separation from the ground or soil on which the tent structure 10 is deployed. More particularly, the floor section 60 may be attached to the flexible cover 30 using one or more fasteners 24, which could include, by way of example, hook and loop textiles, buckles, snaps, tie strings, buttons and button holes, or any other similar type of fastening mechanism.

As shown and described, the flexible cover 30 may be flexible to allow for ready assembly, disassembly, and storage. The flexible cover 30 may be manufactured from most any type of lightweight, flexible textile, such as nylon ripstop or similar types of polyester fabrics. Alternative and additional materials that may be used to manufacture the flexible cover 30 include polyester, canvas, polyethylene, flexible polyvinyl chloride (PVC), as well as other flexible textiles, synthetic plastic polymers, and poly-type materials.

As an additional feature of another embodiment of the vehicle cargo bay tent structure 10, the flexible cover 30 could be manufactured to include photochromic features in part or all of the flexible cover 30 surface area. Such photochromic properties would allow the cover 30 to be clear in low light or night conditions, and to be substantially tinted in full light or daylight conditions. The tinting of the cover 30 in full light or daylight provides users with further protection from potentially harmful UV sunlight.

In order to balance strength, durability, and weight, the ribs 20 may be manufactured from any type of resilient thermoplastic or composite material. With the ribs 20 being manufactured from a resilient thermoplastic, the ribs 20 may be readily formed into a figure-8 shape and folded into a compact size for transport and storage. When fully collapsed, the vehicle cargo bay tent structure 10 is designed to be fairly compact, and storable a storage bag or sack (not shown).

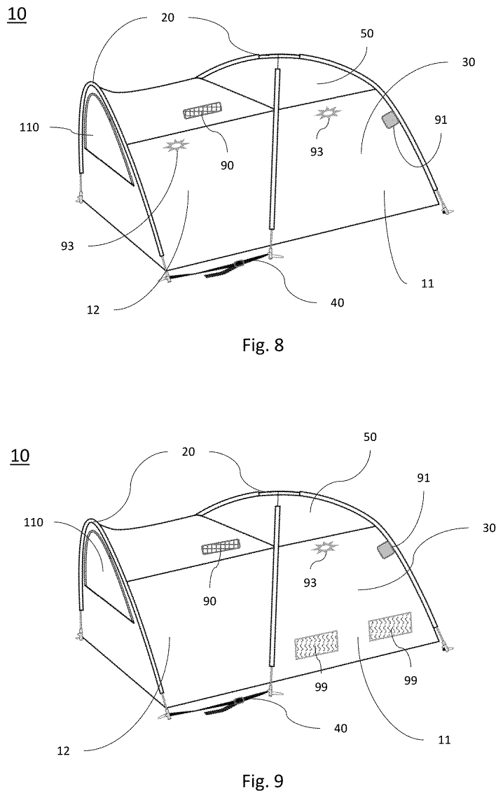

In a further embodiment, having a further enhanced feature, the vehicle cargo bay tent structure 10 may incorporate, as shown in FIG. 8, solar panels or photovoltaic (“PV”) panels 90 on or embedded within the flexible cover 30. Such photovoltaic panels 90 may be used to generate electrical power during the day when sunlight hits the panels 90. The photovoltaic panel 90 electrical power can be used to operate lights 93 or for recharging any type of rechargeable electrical devices. For improved useability, the tent structure 10 could further include electrical power storage units, such as batteries 91, such that the electrical power generated by the photovoltaic panels 90 during the daylight would be stored in the batteries 91, and then able to be used to power lights 93 during the evening and night hours. The use of light emitting diodes (LEDs) would provide the most efficient use of electrical power generated by the photovoltaic panels, and would provide additional safety over incandescent bulbs, which tend to generate excess heat.

In another embodiment relating, in part, to the above PV panel embodiment, the vehicle cargo bay tent structure 10 may further incorporate, as shown in FIG. 9, one or more electrical heating elements 99 embedded into one or more sides of the tent structure, or embedded into a floor section of the tent structure 10. The heating elements 99, may be standard resistor-type or carbon fiber heating elements used within a variety of apparel, blankets, or mats.

When the heating elements 99 are activated, they provide heat and warmth to the interior of the tent structure 10 for added comfort for occupants. The heating elements 99 may draw electrical power from any available power source, including the tent structure batteries 91, a separate power source (not shown) such as a separate battery, or by drawing electrical power from the vehicle in which the tent structure is deployed. The heating elements 99 can be embedded into the flexible cover 30, or attached to the interior of the flexible cover 30 as a separate sheet, mat, or alternatively as a string element to be placed by the user.

In a further embodiment, as suggested above, the vehicle cargo bay tent structure 10 may include an electrical connection 95 to allow the tent structure 10 to draw electrical power from the vehicle, and thereby power any lights 93, any heating elements 99, or possibly provide power for charging other equipment such as cell phone, tables, and/or laptops.

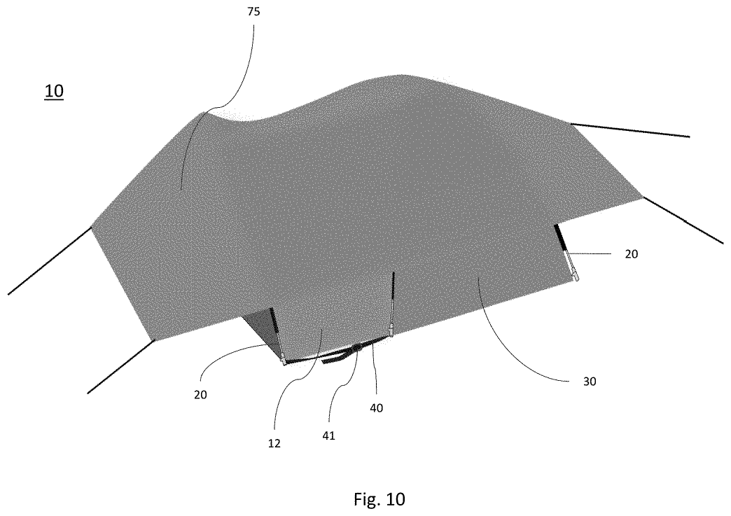

To provide additional protection for the tent structure 10 and users of the tent structure 10, especially from rain or other precipitation, an additional cover sheet 75 may be placed over the deployed tent structure 10, as shown in FIG. 10. The cover sheet 75 may be held in place by guy lines or tie-downs attached to the ground surrounding the tent structure 10 or to any stable surface or structure around the tent structure 10.

The adjustable vehicle cargo bay tent structure 10 may also include pockets or bags (not shown) for use to weigh down or provide ballast to the modules. For example, at the beach, sand can be easily placed in the bag sections, whereas for use with camping or non-beach activities, stones or a plurality of smaller rocks can be placed in the bag sections or pockets to provide additional weight or ballast. When it is time to collapse and transport the vehicle cargo bay tent structure 10, the sand, stones, or small rocks may be readily removed from the bag sections, and disassembly or folding is easily achieved.

The drawings and disclosed embodiments are but a limited set of examples of how the inventive adjustable vehicle cargo bay tent structure 10 may be used. For example, while the tent structure 10 is described as being deployed in the cargo bay of a vehicle, such as a pickup truck, other uses may be equally beneficial or relevant to users. Such other uses may include, without limitation, beach, camping, and other outdoor activities, such as use within a garden, at sporting events, a party shelter, a reading spot, a safe enclosure for pets, a leisure/quiet place, and/or set up and used by various commercial entities such as temporary covered spots by restaurants, spas, or resorts.

While preferred embodiments of the inventive adjustable vehicle cargo bay tent structure 10 have been described and disclosed, in particular by reference to certain figures and exemplary embodiments relating to particular shapes, and configurations for the tent structure 10, such embodiments for the tent structure 10, are not to be construed as limiting the scope of application of the inventive devices or systems. For example, as described and claimed, the adjustable tent structure 10 may be configured having different sizes and shapes based upon the number and configuration of the flexible ribs 20. Such variations to the tent structure 10 may include different shapes, and/or with the tent structure having multiple doors or windows incorporated into the cover 30. All such alternate embodiments are deemed to be within the scope of the inventive design and below claims.

It will be recognized by those skilled in the art that other modifications, substitutions, and/or other applications are possible, and all such modifications, substitutions and applications are within the true scope and spirit of the present invention. It is likewise understood that the above disclosure and attached claims are intended to cover all such modifications, substitutions, and/or applications.

What is claimed is:

1. An adjustable tent structure for use in a vehicle cargo bay, comprising:
A plurality of flexible ribs that form a skeletal shape for a main section of said adjustable tent structure and a skeletal shape for an entryway of said adjustable tent structure;
A flexible cover attachable to said plurality of flexible ribs to form said main section and said entryway of said tent structure;
At least one adjustable connecting strap, having an adjustable length, wherein said at least one adjustable connecting strap is connected at one end to an end of one of said plurality of flexible ribs, and connected at the other end of said adjustable connecting strap to an end of a second of said plurality of flexible ribs, wherein by increasing the length of said at least one adjustable connecting strap increases the length of said tent structure entryway, and by decreasing the length of said at least one adjustable connecting strap decreases the length of said tent structure entryway; and
A plurality of tie-down elements to attach said plurality of flexible ribs and said flexible cover to a stable element.

2. The adjustable tent structure, as described in claim 1, wherein said tent structure further comprises at least one openable door at an end of said entryway of said tent structure.

3. The adjustable tent structure, as described in claim 1, wherein said tent structure further comprises at least one openable window within said flexible cover.

4. The adjustable tent structure, as described in claim 1, wherein said plurality of flexible ribs are manufactured from at least one of thermoplastic material, aluminum, steel, and fiberglass.

5. The adjustable tent structure, as described in claim 1, wherein said flexible cover is formed from at least one of nylon ripstop material, and canvas material.

6. The adjustable tent structure, as described in claim 1, wherein said flexible cover is at least partially manufactured from a synthetic plastic polymer including at least one of a polyethylene material and a polyvinyl chloride material.

7. The adjustable tent structure, as described in claim 1, wherein said plurality of tie-down elements connect said adjustable tent structure to said vehicle.

8. The adjustable tent structure, as described in claim 1, wherein said plurality of tie-down elements connect said adjustable tent structure to said vehicle cargo bay.

9. The adjustable tent structure, as described in claim 1, wherein said plurality of tie-down elements connect said adjustable tent structure to a rigid surface surrounding said vehicle.

10. The adjustable tent structure, as described in claim 1, wherein said tent structure further comprises a transparent top section.

11. The adjustable tent structure, as described in claim 1, wherein said flexible cover has photochromic features for at least 50% of a roof section of said flexible cover, such that said roof section is clear in low light or night conditions, and is substantially tinted in full light or daylight conditions.

12. The adjustable tent structure, as described in claim 1, further comprising at least one photovoltaic panel attachable to at least a portion of said tent structure roof section.

13. The adjustable tent structure, as described in claim 12, further comprising at least one light emitting diode electrically connected to said at least one photovoltaic panel.

14. The adjustable tent structure, as described in claim 12, further comprising at least one energy storage device to store electrical power generated by said at least one photovoltaic panel.

15. The adjustable tent structure, as described in claim 1, further comprising at least one heating element embedded within at least one side of said tent structure or embedded within a floor section of said tent structure.

16. The adjustable tent structure, as described in claim 1, further comprising an electrical connector to draw electrical power from said vehicle.

17. An adjustable tent structure for use in a vehicle cargo bay, comprising:
A first and second flexible rib that cross each other in an approximate orthogonal configuration to form a skeletal shape for a main section of said adjustable tent structure;
A third flexible rib that forms a skeletal shape for an entryway of said adjustable tent structure;
A flexible cover attachable to said first, second, and third flexible ribs to form said main section and said entryway of said tent structure;
At least one adjustable connecting strap, having an adjustable length, wherein said at least one adjustable connecting strap is connected at one end to an end of one of said first flexible rib, and connected at the other end of said adjustable connecting strap to an end of said third flexible rib, wherein by increasing the length of said at least one adjustable connecting strap increases the length of said tent structure entryway, and by decreasing the length of said at least one adjustable connecting strap decreases the length of said tent structure entryway; and
A plurality of tie-down elements to attach said first, second, and third flexible ribs, and said flexible cover to a stable element.

18. The adjustable tent structure, as described in claim 17, wherein said tent structure further comprises at least one openable door at an end of said entryway of said tent structure.

19. The adjustable tent structure, as described in claim 17, wherein said tent structure further comprises at least one openable window within said flexible cover.

20. The adjustable tent structure, as described in claim 17, wherein said first, second, and third flexible ribs are manufactured from at least one of thermoplastic material, aluminum, steel, and fiberglass.

21. The adjustable tent structure, as described in claim 17, wherein said flexible cover is formed from at least one of nylon ripstop material and canvas material.

22. The adjustable tent structure, as described in claim 17, wherein said flexible cover is at least partially manufactured from a synthetic plastic polymer including at least one of a polyethylene material and a polyvinyl chloride material.

23. The adjustable tent structure, as described in claim 17, wherein said plurality of tie-down elements connect said adjustable tent structure to said vehicle.

24. The adjustable tent structure, as described in claim 17, wherein said plurality of tie-down elements connect said adjustable tent structure to a rigid surface surrounding said vehicle.

25. The adjustable tent structure, as described in claim 17, further comprising at least one heating element embedded within at least one side of said tent structure or embedded within a floor section of said tent structure.

26. The adjustable tent structure, as described in claim 17, further comprising an electrical connector to draw electrical power from said vehicle.
